(19) United States
(12) Patent Application Publication
(10) Pub. No.: US 2016/0217378 A1
(43) Pub. Date: Jul. 28, 2016

(54) IDENTIFYING ANOMALOUS BEHAVIOR OF A MONITORED ENTITY

(71) Applicant: HEWLETT PACKARD ENTERPRISE DEVELOPMENT LP, Houston, TX (US)

(72) Inventors: Gowtham Bellala, Palo Alto, CA (US); Manish Marwah, Palo Alto, CA (US); Martin Arlitt, Calgary (CA); Amip J. Shah, Santa Clara, CA (US)

(21) Appl. No.: 14/914,141

(22) PCT Filed: Aug. 30, 2013
(86) PCT No.: PCT/US2013/057612

§ 371 Date: Feb. 24, 2016

(51) Int. Cl. G06N 5/04; G06N 99/00

(52) U.S. Cl. CPC G06N 5/04; G06N 99/005

(57) ABSTRACT

Described herein are techniques for identifying anomalous behavior of a monitored entity. Features can be extracted from data related to operation of an entity. The features can be mapped to a plurality of states to generate a state sequence. An observed value of a metric can be compared to an expected value of the metric based on the state sequence.

### BACKGROUND

Cyber-physical systems, such as buildings, contain entities (e.g., devices, appliances, etc.) that consume a multitude of resources (e.g., power, water, etc.). Efficient operation of these entities is important for reducing operating costs and improving the environmental footprint of these systems. For example, it has been reported that commercial buildings spend over $100 billion annually in energy costs, of which 15% to 30% may constitute unnecessary waste due to inefficient operation of equipment, faulty equipment, or equipment requiring maintenance.

### BRIEF DESCRIPTION OF DRAWINGS

The following detailed description refers to the drawings, wherein:

FIG. 1 illustrates a method of identifying anomalous behavior of a monitored entity, according to an example.

FIG. 2 illustrates a method of generating a state machine model, according to an example.

FIG. 3 illustrates a computing system for identifying anomalous behavior of a monitored entity, according to an example.

FIGS. 4(a)-4(f) illustrate a use case example of anomaly detection for a chiller system, according to an example.

FIG. 5 illustrates a computer-readable medium for identifying anomalous behavior of a monitored entity, according to an example.

### DETAILED DESCRIPTION

According to techniques described herein, one or more entities can be monitored to identify anomalous behavior. In one example, various sensors associated with an entity (e.g., device, appliance) can collect data regarding various operating parameters of the entity over a period of time. Features can be extracted from the data and mapped to multiple states. This mapping can result in a state sequence characterizing the operation of the entity over the period of time. An expected value of a metric (e.g., performance metric, sustainability metric) may then be determined based on the state sequence. The expected value can be determined using a state machine model that represents normal operation of the entity and extrapolating an expected value of the metric given the mapped state sequence of the entity. The determined expected value of the metric can then be compared to an observed value of the metric. The observed value may be derived from the collected data or alternatively could be externally determined (e.g., power usage over a one month period can be determined by looking at an electric bill). If the observed value differs from the expected value by a threshold amount, this can be an indication of anomalous behavior of the monitored entity. In some examples, the entity may be a larger system that includes multiple components, each component itself being an entity.

Using these techniques, equipment can be monitored over time to identify inefficient operation or performance degradation (e.g., drift), or to proactively identify equipment requiring maintenance, so as to minimize interruptions at inopportune times. These techniques can efficiently incorporate the effect of external factors on the operating behavior of cyber-physical systems, in determining anomalous behavior. Furthermore, rather than mere single-point anomaly detection, these techniques incorporate multiple test points over a period of time from various sensors. Accordingly, these techniques can be more accurate and effective since they are able to consider anomalies across a greater amount of data, over a longer period of operation of monitored equipment. As a result, slight shifts or drift in the performance of equipment can be more ably detected, timely detection of which can result in significant cost and resource savings. Additionally, when multiple entities are monitored and analyzed together, the disclosed techniques can capture interactions between the entities, and their correlations, resulting in anomaly alerts when those interactions/correlations change. This can help to prevent major system failure or breakdown. Additional examples, advantages, features, modifications and the like are described below with reference to the drawings.

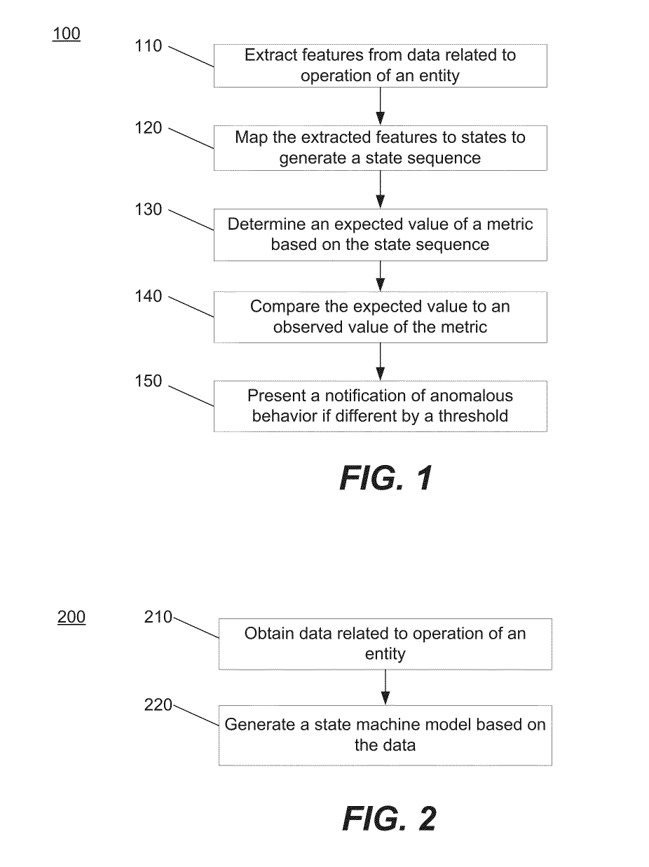

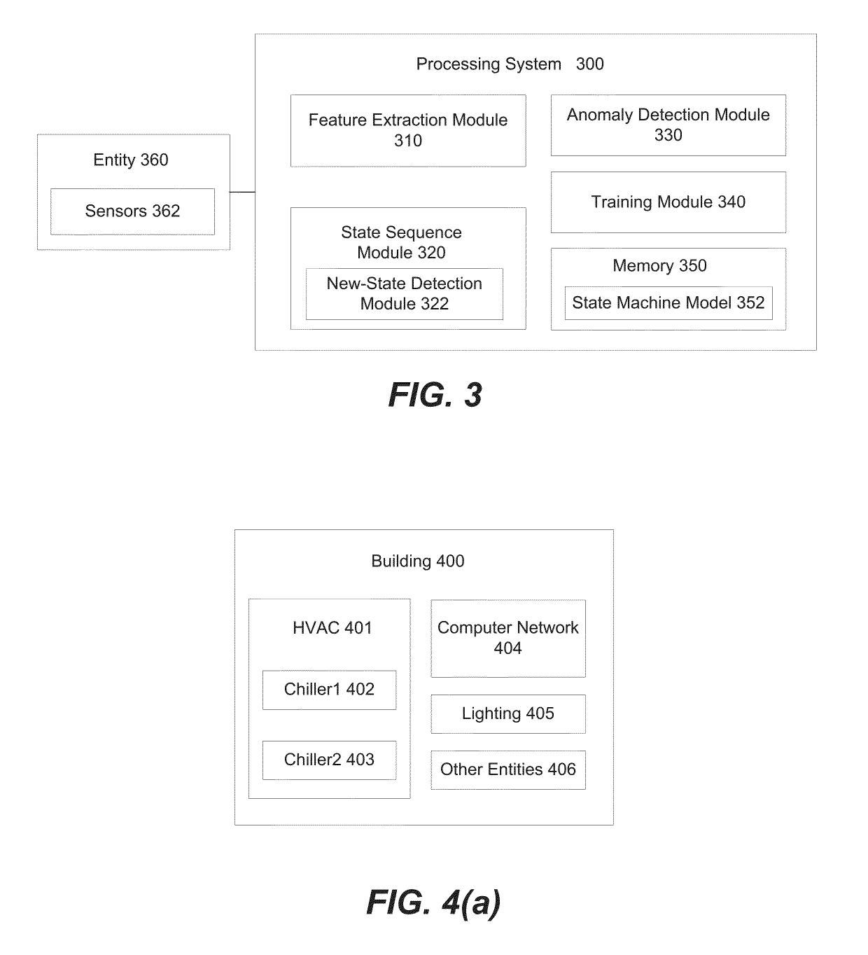

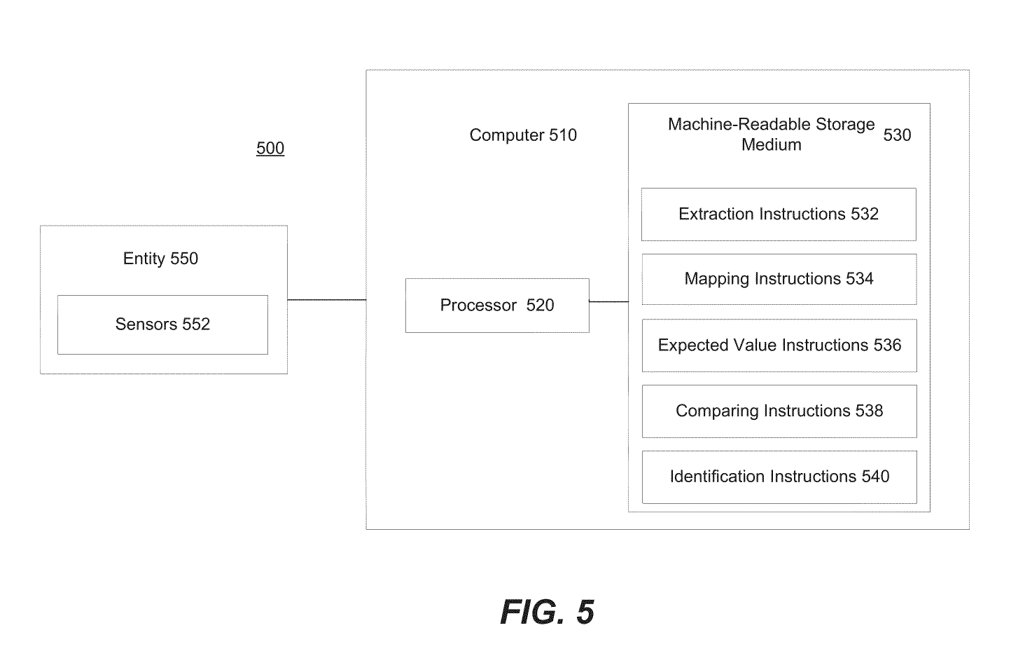

FIG. 1 illustrates a method of identifying anomalous behavior of a monitored entity, according to an example. Method 100 may be performed by a computing device, system, or computer, such as processing system 300 of FIG. 3 or computing system 500 of FIG. 5. Computer-readable instructions for implementing method 100 may be stored on a computer readable storage medium. These instructions as stored on the medium are referred to herein as “modules” and may be executed by a computer.

Method 100 will be described here relative to example processing system 300 of FIG. 3. System 300 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 300 may include one or more machine-readable storage media separate from the one or more controllers, such as for storing the modules 310-340 and state machine model 352.

Method 100 may begin at 110, where features may be extracted from data related to the operation of an entity 360 using a feature extraction module 310. The entity 360 may be a device, appliance, or system and may be part of a cyber-physical system, such as a building. The entity 360 may consume one or more resources, such as electricity, gas, water, or the like.

In some examples, the entity 360 may be a larger system that includes multiple components, each component itself being an entity. For instance, the entity 360 may be an HVAC system, which itself may be comprised of several other entities such as pumps, blowers, air handling units, and cooling towers. When multiple entities are monitored and analyzed together, the disclosed techniques can capture interactions between the entities, and their correlations, resulting in anomaly alerts when those interactions/correlations change. This can help to prevent major system failure or breakdown.

The data recorded during operation of the entity 360 may be reported by sensors 362 or other devices (referred to as “sources”). The sensors 362 may be located at different portions of the monitored entity to monitor one or more parameters of the entity 360. For example, some parameters that may be monitored are air flow rate, water flow rate, temperature, pressure, power, revolutions per time period of a fan, and other parameters. Some sensors may be located at other areas away from the monitored entity 362, such as a temperature sensor in a room of a building. Other parameters that may be monitored are settings, such as a thermostat setting, or the external weather. The sensors and devices may be part of a building management system (BMS). All of the monitored parameters may be reflected in the recorded data. The recorded data may cover the operational parameters of the entity over a period of time. The period of time can be any of various periods of time, ranging from a number of minutes to a number of years, including periods like a day, a week, a month, or a year.

Before feature extraction, the collected data may be preprocessed. For example, the collected data may be preprocessed through a data fusion operation, a data cleaning operation, etc. The data fusion operation may include, for instance, merging (or joining) data from multiple sources. The data from multiple sources may be fused because the multiple sources may have different timestamps, may collect data at different frequencies, may have different levels of data quality, etc. The data cleaning operation may include, for instance, removing data outliers, removing invalid values, imputing missing values, etc. The collected data may be preprocessed through implementation of any suitable preprocessing techniques.

The feature selection of the data (whether pre-processed or not) may include an identification of the features that affect the operating behavior of the entity. If the entity is a new entity which is being modeled for the first time, feature selection can be performed “fresh”, meaning one or more of the below feature selection and dimensionality reduction techniques may be performed to select the most relevant features (i.e., those features that are determined to affect the operating behavior of the entity). In such a case, a state machine model 352 may be generated during a training phase.

For example, training module 340 may be used to build a state machine model based on data recorded during operation of the entity (or another entity of the same type). Referring to FIG. 2, the training module 340 may perform method 200 by obtaining data related to operation of an entity at 210, and generating a state machine model based on the data at 220. The data may relate to operation of the entity over an extended period of time, such as three months or more. In general, the more data used for training, the more accurate the state machine model will be.

The feature selection of the preprocessed data may include selection of a subset of the most relevant features from a set of all of the features. The subset of the most relevant features may be selected based upon a correlation or other determined relationships between features and performance metrics of the entity. For this purpose, any of a number of known automated feature selection methods may be used, for example, using subset selection, using a metric such as correlation, mutual information, using statistical tests such as chi-squared test, using wrapper-based feature selection methods, etc. In addition to the automated feature selection methods listed above, a domain expert may also select, discard, or transform features or variables.

In addition to feature selection, dimensionality reduction may be applied to the data Dimensionality reduction of the preprocessed data may include mapping of all of the features or a subset of all of the features from a higher dimensional space to a lower dimensional space. The dimensionality reduction may be implemented through use of, for instance, principal component analysis (PCA), multi-dimensional scaling (MDS), Laplacian Eigenmaps, etc. Thus, according to an example, the transforming of the preprocessed data may result in a relatively smaller number of features that characterize the operation of the entity. Particularly, those features that may not impact the entity may be discarded. As another example, features that impact the entity but that may be redundant with other variables may be discarded through the dimensionality reduction.

The generated state machine model 352 may comprise a plurality of states characterizing different operational behavior of the entity and relating the different states to one or more metrics (e.g., performance metrics, sustainability metrics, etc.). The states can be viewed as an abstraction of the entity's operation over a period of time. For example, the recorded data can represent a time series of observed/sensed behavior of the entity and of other parameters (e.g., weather) over the period of time. Each state represents an abstraction of a type of operating behavior of the entity during some portion of the period of time. For instance, a state machine model generated for a chiller may include five states characterizing different operational behavior of the chiller over the course of the training (e.g., an “off” state and various “on” states characterizing different sustained levels of operation of the chiller—e.g., at different thermostat settings in combination with different ambient temperatures). Such a state machine model for the chiller may also be correlated with various metrics for each of the defined five states, such as a performance metric related to average energy consumption during each of the states. Additionally, the state machine model may be associated with multiple feature patterns that map various feature values with the different states and with transitions between the states. Additional information regarding feature selection, dimensionality reduction, and building a state machine model according to these techniques can be found in co-pending U.S. patent application Ser. No. 13/755,768, filed on Jan. 31, 2013, which is herein incorporated by reference.

On the other hand, if the given entity or another entity of the same type has been characterized (trained) earlier using this framework, then the features used earlier (i.e., during training) may be selected. By using the same feature selection and dimensionality reduction techniques, the same features may be extracted for mapping into states of the state machine model.

At 120, the extracted features may be mapped to a plurality of states to generate a state sequence using a state sequence module 320, At least some of the states may be distinct from the others. The extracted features may be mapped according to a state machine model 352 stored in memory 350.

The extracted features may be mapped into multiple states using the feature patterns associated with the state machine model 352. As a result, a state sequence may be generated that characterizes the operation of the entity 360 during the monitored time period. In some cases, a series of the extracted features may not map well into the states based on the feature patterns. In such a case, the extracted features may be flagged as potentially indicative of a new state. This may be handled by the new-state detection module 322 of the state sequence module 320. The extracted features could be ignored during the current processing and a best possible state sequence could be generated for use in method 100. The flagged features could then be revisited during a later training phase. For example, all of the data or the extracted features might be considered in a subsequent training phase in order to identify and add new states and/or feature patterns to the state machine model 352. In particular, the state machine model 352 might be updated by the training module 340 either periodically by re-training the entity periodically (e.g., every 1 month, 3 months, etc.) or by re-training whenever a new state is detected by new-state detection module 322.

At 130 and 140, an expected value of a metric may be determined based on the state sequence and compared with an observed value of the metric using anomaly detection module 330. The metric may be any of various metrics, such as a performance metric or sustainability metric. Such metrics may include a measure of resource consumption (e.g., power, water, gas, etc.), efficiency of operation (e.g., coefficient of performance (COP)), failure rate, environmental impact (e.g., carbon footprint, toxicity, etc.), or any other measure of interest including, for instance, maintenance cost, any usage patterns the entity exhibits (e.g., daily usage cycle), etc. Additionally, multiple metrics may be examined, such that a divergence between the expected value and observed value of any one of the metrics or a combination of the metrics can indicate anomalous behavior.

The observed value of the metric may be derived from the recorded data or extracted features. Alternatively, the observed value of the metric may be externally determined, such as with reference to a utility bill indicating power consumption. The expected value of the metric may be determined based on the state sequence with reference to the state machine model. For example, the characteristics of the metric value in the corresponding states as observed during the training phase can be used to determine the expected value of the metric for each state in the state sequence. Various techniques may be used to compute the expected value of the metric and compare it with an observed value of the metric. For example, a mean value comparison technique, a distribution comparison technique, or a likelihood comparison technique may be used.

In mean value comparison, the expected mean value of the metric can be computed based on the mean values of that metric for each state. Given a state sequence, let wᵢ denote the fraction of instances of an entity in state i, and let uᵢ be the mean value of the sustainability metric in that state. Then, the expected value of the sustainability metric for the given state sequence can be computed as (Σwᵢ*uᵢ)/(Σwᵢ). The absolute difference between this value and the observed mean value can be compared against a threshold to determine if the test sequence is anomalous or not. This threshold value may depend on the length of the test sequence, i.e., the number of test points. If the sequence is a time series, as its duration increases the threshold value decreases. For example, the threshold, T, can be determined as follows:

p=λ·exp(−Δt²/B)

T=m_{ref}/p

Where Δt is the duration of the sequence, B is a bandwidth parameter, λ is a scaling parameter, and m_{ref} is the expected value of the metric computed above.

In distribution comparison, the entire distributions of the metric can be compared rather than their mean values alone. Using the same notation as above, the expected distribution of the sustainability metric is given by (Σwᵢ*fᵢ)/(Σwᵢ), where fᵢ is the distribution of the sustainability metric in state i. This distribution is then compared to the observed distribution (which is computed from the observed values during the test period) to identify any anomalous activity. The two distributions can be compared using a number of techniques, such as degree of overlap, Kullback-Leibler divergence, or by using statistical tests such as the Kolmogorov-Smirnoff test.

In likelihood comparison, the likelihood of the observed metric sequence can be computed given the underlying states. In addition, likelihood values for several randomly generated metric sequences given the same underlying state sequence can be computed. The observed likelihood value may then be compared with the distribution of likelihood values generated from random sequences to determine the anomalousness of the state sequence.

At 150, a notification of anomalous behavior can be presented, such as via a user interface, if the observed value of the metric differs from the expected value of the metric by a threshold amount. The threshold amount may be measured in accordance with the comparison technique, as described above. The anomalies may be presented in an ordered or ranked fashion according to a level of importance of the different anomalies. For example, for a given anomaly type, the occurrences could be listed from largest violation to smallest (rather than in the order that the violations occurred). A largest violation may be determined by the magnitude of the deviation of the observed value from the expected value of the metric, potential cost savings that could be achieved by addressing the anomaly, or as determined by a user-defined cost function, severity of the anomaly (e.g., will it result in entity failure, will it merely cause occupant discomfort), and business impact. Similarly, some anomaly types could have greater consequences than others (e.g., an overheated motor could require immediate attention to prevent a mechanical failure, while a conference room that is slightly warmer than normal might not require any attention from the facilities staff). Thus, the user interface could be configured to present the anomalies in a manner that enables the facilities staff to act on the highest priority items first.

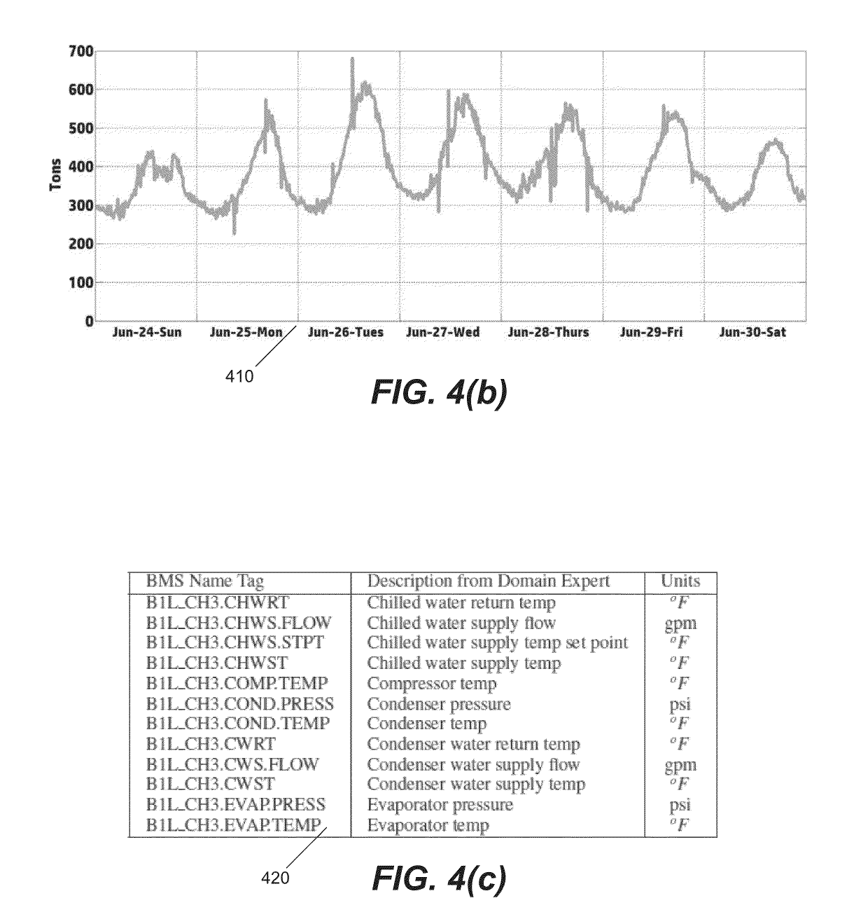

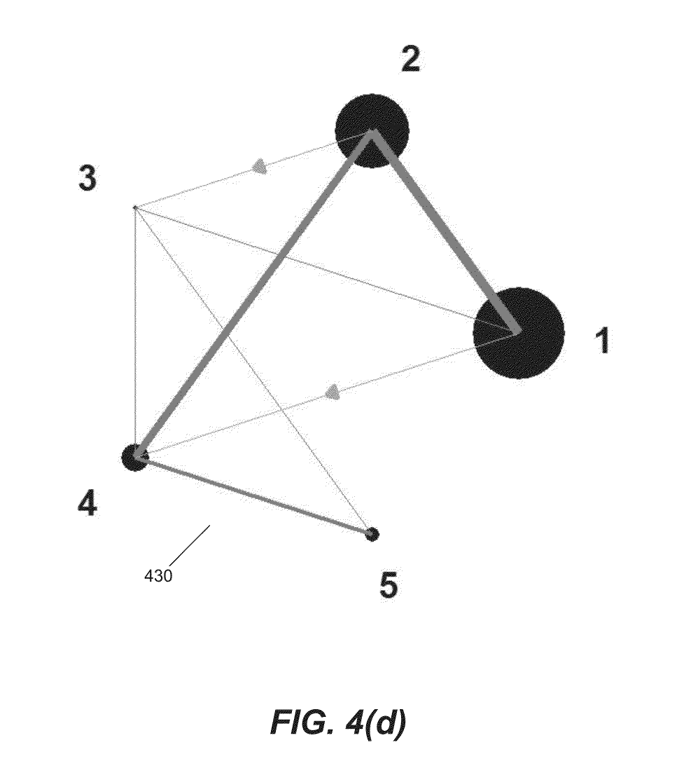

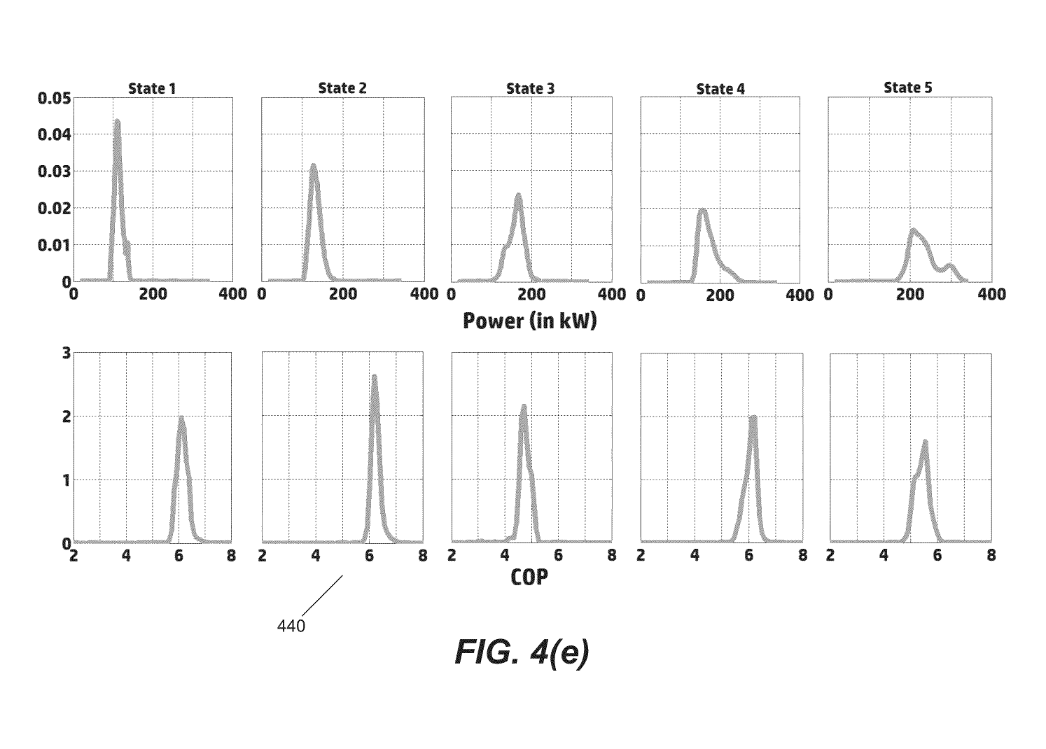

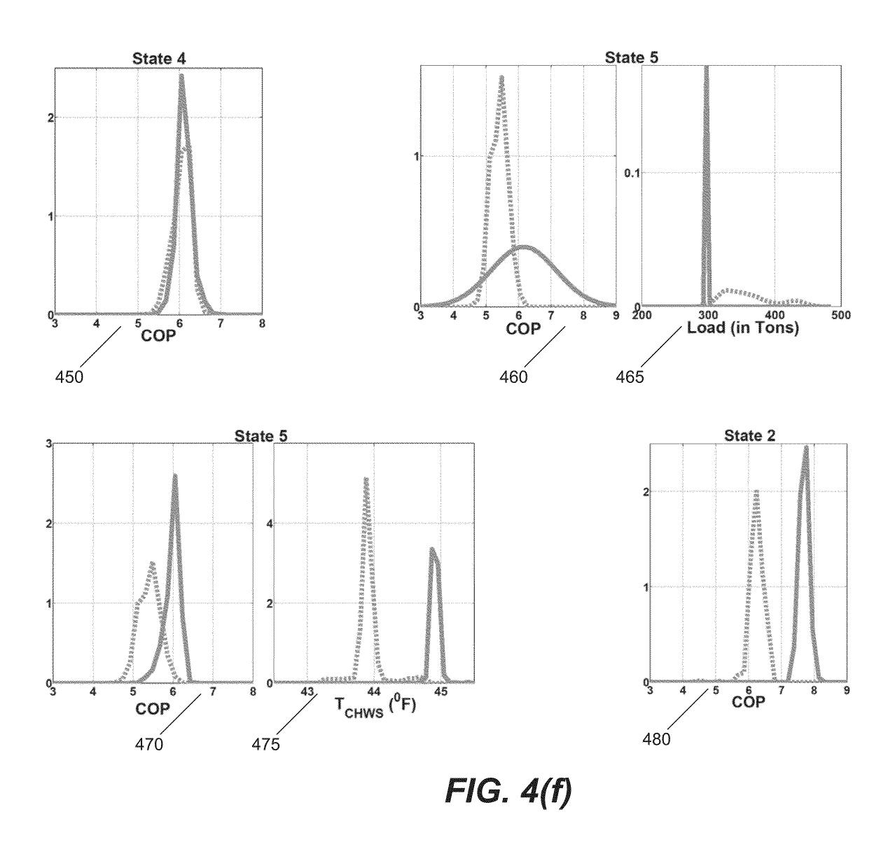

FIGS. 4(a)-4(f) illustrate a use case example of anomaly detection for a chiller system, according to an example. FIG. 4(a) illustrates a building 400 with multiple entities. The building 400 includes an HVAC system 401 that includes two chillers, chiller1 402 and chiller2 403. In this example, chiller1 and chiller2 are water-cooled chillers. The HVAC system 401 may include many other entities as well, such aspumps, blowers, air handling units and cooling towers. The building 400 also includes a computer network 404 that includes multiple computers and other devices, as well as lighting 405. Building 400 may also include other entities 406. The anomaly detection techniques described herein can be used to monitor the behavior of all of these entities and detect anomalous behavior. Here, an example of monitoring and analyzing chiller1's behavior is illustrated through FIGS. 4(b)-4(f).

FIG. 4(b) depicts a graph 410 showing the load of chiller1 and chiller2 over a one week period. The chiller load corresponds to the amount of heat that is generated (and thus need to be dissipated) by the operation of the building. It is specified in Tonnes (Tons). In this example, the chiller load is one of the sustainability metrics.

FIG. 4(c) depicts a chart 420 listing a subset of example parameters corresponding to the operation of chiller1 that are measured and reported by sensors. Measurements of these parameters over a time period (thus creating a time series for each parameter) may constitute the recorded data referenced throughout the above description. For example, a log of these measured parameters can be maintained over the time period. In this example, the parameters were sampled every five minutes for a period of five months. Each individual parameter may be a potential feature selected through the feature selection and dimensionality reduction techniques. Some features may not map directly to a single parameter, but may be based on a combination of parameters or based on partial data for a single or combination of parameters.

Here, the feature extraction technique was based on a control volume approach where the chiller was considered as a black box and the initially selected features corresponded to the input and output parameters to this black box. These features correspond to chilled water supply temperature (TCHWS), chilled water return temperature (TCHWR), chilled water supply flow rate (fCHWS), condenser water supply temperature (TOWS), condenser water return temperature (TCWR), and condenser water supply flow rate (fCWS).

The initially selected features were then correlated. Redundant features were removed by projecting the data onto a low-dimensional space. The dimension reduction was performed in two stages. In the first stage, domain knowledge was used to reduce the feature dimensions, followed by projection using principal component analysis (PCA). Other dimensionality reduction techniques could be used as well, such as multidimensional scaling or Laplacian Eigenmaps.

Domain knowledge was used to reduce the feature space from the initial six features to the following four features, TCHWR, (TCHWR−TCHWS)*fCHWS (which is proportional to the amount of heat removed from the chilled water loop, i.e., chiller load), TOWS, and (TCWR−TCWS)*fCWS (which is proportional to the amount of heat removed from the condenser water loop). The obtained feature space was further reduced using PCA, where the first two principal dimensions were chosen, which capture about 95% of the variance in the feature data.

Then, the projected data was partitioned into clusters, where each cluster represents an underlying operating state of the device. The clusters are determined using the k-means algorithm based on the Euclidean distance metric. The output of this algorithm corresponds to a state sequence s[n],n=1, . . . , N, where s[n] {1, . . . , k} with k denoting the number of clusters (or states). Using this state sequence, the a priori probability of a device operating in state i can be estimated, as well as the probability of the device transitioning from state to state j.

FIG. 4(d) illustrates a state transition diagram 430 for chiller1 based on three months of training data. The feature data has been partitioned into five clusters leading to five different states. The nodes in this figure correspond to the operating states of the chiller, where the size of a node determines its frequency of occurrence. The edges denote the state transitions. Uni-directional transitions occur from state 1 to state 2 and from state 2 to state 3. The rest of the edges indicate bi-directional transitions between states. Self transitions (i.e., transitions within the same state) are not shown. The thickness of the edges corresponds to the frequency of occurrence of the transition.

The operating behavior of the chiller in each of these states can be characterized in terms of its power consumption and its efficiency of operation as measured by Coefficient Of Performance (COP). FIG. 4(e) shows the probability density function (pdf) of the chiller power consumption and COP in each of the 5 states. In this example, the density functions are estimated using the kernel density estimate with a Gaussian kernel.

Graphs 440 of FIG. 4(e) show that the chiller operates at a lower efficiency in states 3 and 5 with a mean COP value of 4.74 and 5.43, as compared to states 1, 2, and 4 whose mean COP values are 6.12, 6.26, and 6.09, respectively. Using these efficiency values, the states can be characterized into “good” (higher efficiency) and “bad” (lower efficiency) states. Ideally, the chiller would operate only in the “good” states. The cause for a transition from a “good” state to a “bad” state can be identified via the transition parameters. The state transitions capture the dynamics of the operation of a device. Each transition exhibits a unique parameter in terms of the input features responsible for the transition.

The state machine model will now be used to assess the performance of chiller1 with respect to its past performance, as well as with respect to its peer—chiller2. An advantage of assessing the performance of the chiller within each state is that it ensures comparison under similar input/external conditions, thereby allowing for a fairer assessment of performance.

Here, the recorded chiller data was partitioned into two sets. The state machine model was trained based on a first set containing three months of data (training data), and the remaining two months of chiller data was used for performance assessment within each state (test data). This second set of data was further partitioned into six different test samples, where each sample consisted of ten consecutive days of chiller data.

For each sample, the feature data was projected onto the principal dimensions learned during the training phase, and each projected data point was assigned to its nearest state (or cluster). The distribution of the chiller COP in the training data was then compared with that of the test data, for each state. An anomaly flag was raised if these two distributions were significantly different, as quantified by the Kullback-Leibler divergence or an overlap measure.

FIG. 4(f) demonstrates the performance assessment results for four different test samples, where the performance assessment results are shown in one state for each case. The dotted curves correspond to the chiller COP or feature distribution in the training data, and the solid curves correspond to that of the test data.

Graph 450 demonstrates a normal scenario, where the chiller COP behavior in the test phase is similar to that during the training phase. Graph 460 demonstrates a scenario where the chiller COP distribution in the test phase is significantly different from that of the training phase. To identify the cause for this anomalous behavior, the distribution of the input features was examined to look for features that had a significantly different distribution in the test data as compared to the training data. In this case, the chiller load was identified to have a significantly different distribution, as shown in graph 465.

On further examination, the cause for this change in load distribution was identified to be that of a sensor error, where the sensor monitoring the chiller load temporarily stopped refreshing its readings, resulting in the spike at around 300 Tons. However, the true load during this period could have been different, and hence the time points assigned to state 5 could correspond to other states. This example is an instance of a temporal anomaly, and it can be further categorized into a “sensor malfunction” or “hardware issues” anomaly category.

Graph 470 demonstrates a second anomalous scenario where the chiller's performance improved in the test sample as compared to that of the training period. To identify the cause for this anomalous behavior, the feature distributions in the training data were compared with that of the test sample. In this case, the chilled water supply temperature TCHWS (which serves as a proxy to the set point temperature) was identified to have been increased over this period, as shown in graph 475, resulting in an improved performance.

These three examples correspond to the scenario where the chiller's performance is assessed with respect to its past performance. Performance assessment of the chiller can be made with respect to its peers, under similar conditions. Here, chiller1 and chiller2 are identical (same brand, model and capacity). Hence, the performance of these two chillers can be compared in each state, i.e., under virtually identical input conditions. Graph 480 demonstrates the COP behavior of chiller1 (dotted curve) and chiller2 (solid curve) in state 2. This graph reveals that chiller2 has a significantly higher COP than that of chiller1. A similar difference in the COP behavior of the chillers was observed in the remaining four states.

This anomalous behavior could have been caused due to reasons such as different internal settings within the chillers, or due to the continuous operation of chiller1 over a long period resulting in a degradation of its performance. Identifying anomalies that correspond to chiller performance degradation can be very useful, as timely detection of such anomalies could result in huge savings in power consumption. For example, identifying the cause for the anomaly revealed by graph 480 and subsequently improving the COP of chiller1 to that of chiller2 (e.g., through maintenance, changing a setting, etc.) could result in power consumption savings.

FIG. 5 illustrates a system for identifying anomalous behavior in a monitored entity, according to an example. System 500 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to processing system 300, for example.

In addition, users of system 500 may interact with system 500 through one or more other computers, which may or may not be considered part of system 500. As an example, a user may interact with system 500 via a computer application residing on system 500 or on another computer, such as a desktop computer, workstation computer, tablet computer, smartphone, or the like. The computer application can include a user interface (e.g., touch interface, mouse, keyboard, gesture input device).

System 500 may perform methods 100 and 200, and variations thereof. Additionally, system 500 may be part of a larger software platform, system, application, or the like. For example, these components may be part of a building management system (BMS).

Computer 510 may be connected to entity 550 via a network. The network may be any type of communications network, including, but not limited to, wire-based networks (e.g., copper cable, fiber-optic cable, etc.), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 520 may be at least one central processing unit (CPU), at least one semiconductor-based microprocessor, other hardware devices or processing elements suitable to retrieve and execute instructions stored in machine-readable storage medium 530, or combinations thereof. Processor 520 can include single or multiple cores on a chip, multiple cores across multiple chips, multiple cores across multiple devices, or combinations thereof. Processor 520 may fetch, decode, and execute instructions 532-540 among others, to implement various processing. As an alternative or in addition to retrieving and executing instructions, processor 520 may include at least one integrated circuit (IC), other control logic, other electronic circuits, or combinations thereof that include a number of electronic components for performing the functionality of instructions 532-540. Accordingly, processor 520 may be implemented across multiple processing units and instructions 532-540 may be implemented by different processing units in different areas of computer 510.

Machine-readable storage medium 530 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 530 can be computer-readable and non-transitory. Machine-readable storage medium 530 may be encoded with a series of executable instructions for managing processing elements.

The instructions 532-450 when executed by processor 520 (e.g., via one processing element or multiple processing elements of the processor) can cause processor 520 to perform processes, for example, methods 100 and 200, and/or variations and portions thereof.

For example, extraction instructions 532 may cause processor 520 to extract features from data characterizing operation of an entity 550. The data may be received from sensors 552 and may have been recorded over a time period. Mapping instructions 534 may cause processor 520 to map the extracted features to states to generate a state sequence. Expected value instructions 536 may cause processor 520 to determine an expected value of a metric based on the state sequence and a state machine model for the entity. Comparing instructions 538 may cause processor 520 to compare the determined expected value of the metric to an observed value of the metric. Identification instructions 540 may cause processor 520 to identify anomalous behavior if the expected value of the metric differs from the observed value of the metric.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method to identify anomalous behavior of a monitored entity, the method comprising, by a processing system:
extracting features from data related to the operation of an entity;
mapping the extracted features to states to generate a state sequence;
determining an expected value of a metric based on the state sequence; and
comparing the determined expected value of the metric to an observed value of the metric.

2. The method of claim 1, further comprising:
presenting, via a user interface, a notification of anomalous behavior of the entity if the observed value of the metric differs from the expected value of the metric by a threshold amount.

3. The method of claim 1, wherein the metric is a performance metric or a sustainability metric.

4. The method of claim 1, wherein the data is reported by sensors monitoring various performance parameters of the entity.

5. The method of claim 4, wherein the data is recorded over the course of at east 24 hours of operation of the entity and the state sequence includes a plurality of distinct states.

6. The method of claim 1, wherein the expected value of the metric is determined using a state machine model previously trained on data related to the operation of one or more other entities of the same type as the entity.

7. The method of claim 1, wherein the expected value of the metric is determined using a mean value comparison technique, a distribution comparison technique, or a likelihood comparison technique.

8. A system to identify anomalous behavior of a monitored entity, the system comprising:
sensors to report data regarding at least two parameters of an entity during operation;
a feature extraction module to extract features from the reported data;
a state sequence module to generate a state sequence by mapping the extracted features to a plurality of states; and
an anomaly detection module to compare an expected value of a metric based on the state sequence to an observed value of the metric.

9. The system of claim 8, further comprising:
a user interface to alert a user of anomalous behavior of the entity if the expected value of the metric differs from the observed value of the metric by a threshold amount.

10. The system of claim 9, wherein the user interface is configured to present a list of detected anomalies ordered by level of importance.

11. The system of claim 8, further comprising:
a training module to build a state machine model based on observed operating parameters of one or more other entities of the same type as the entity.

12. The system of claim 8, further comprising:
a memory storing a state machine model corresponding to the entity,
wherein the anomaly detection module is configured to determine the expected value of the metric using information from the state machine model.

13. The system of claim 12, wherein the plurality of states into which the extracted features are mapped are predetermined based on state patterns in the state machine model.

14. The system of claim 13, wherein the state sequence module comprises a new-state detection module configured to detect a potential new state exhibited by a portion of the extracted features, wherein the potential new state corresponds to a pattern that does not exist in the state machine model.

15. The system of claim 8, wherein the system is configured to identify anomalous behavior in a plurality of monitored entities.

16. The system of claim 15, wherein the data reported by the sensors comprises measured parameters from each of the monitored entities, the state sequence module is configured to generate a state sequence for each of the monitored entities, and the anomaly detection module is configured to detect anomalous behavior in any one of or combination of the monitored entities.

17. The system of claim 15, wherein the plurality of monitored entities is an HVAC system.

18. A non-transitory computer-readable storage medium storing instructions for execution by a computer to identify anomalous behavior of a monitored entity, the instructions when executed causing the computer to:
extract features from data characterizing operation of an entity during a time period;
map the extracted features to states to generate a state sequence;
determine an expected value of a metric based on the state sequence and a state machine model for the entity;
compare the determined expected value of the metric to an observed value of the metric; and
identify anomalous behavior if the expected value of the metric differs from the observed value of the metric.

19. The computer-readable storage medium of claim 18, the instructions when executed causing the computer to receive the data from a plurality of sensors monitoring performance parameters of the entity.
